(19) United States
(12) Patent Application Publication
(10) Pub. No.: US 2026/0182599 A1
(43) Pub. Date: Jul. 2, 2026

(54) EDIBLE FAT-CONTAINING PRODUCTS AND METHODS FOR THEIR PREPARATION

(71) Applicant: Flora Food Global Principal B.V., AMSTERDAM (NL)

(72) Inventors: Georg Christian DOL, AMSTERDAM (NL); Ronald Peter POTMAN, AMSTERDAM (NL); Irene Erica SMIT-KINGMA, AMSTERDAM (NL)

(21) Appl. No.: 19/131,426

(22) PCT Filed: Nov. 23, 2023
(86) PCT No.: PCT/EP2023/082844

§ 371 Date: May 20, 2025

(30) Foreign Application Priority Data
Nov. 25, 2022 (EP) 22209661.2
Feb. 14, 2023 (EP) 23156506.0

(51) Int. Cl. A23D 7/015; A23D 7/00; A23D 7/02

(52) U.S. Cl. CPC A23D 7/015; A23D 7/001; A23D 7/02

(57) ABSTRACT

The invention relates to an edible fat-containing product comprising an aqueous phase and 20-40 wt. % of a fat phase, wt % calculated on the weight of the product. The fat phase comprises a liquid vegetable oil and 5-90 wt % of a structuring fat, wt. % calculated on the fat phase, wherein the structuring fat is an interesterified blend of fats wherein one of the fats in the blend to be interesterified has >95 wt. % C18:0 calculated on the amount of fatty acids of the triglycerides of the fat. The fats in the blend to be interesterified do not contain palm oil or palm oil-derived fractions, and the fats in the blend to be interesterified and the liquid vegetable oil do not contain hydrogenated oil or fat or fractions thereof. The fat phase comprises, calculated on the amount fatty acids of the triglycerides of the fat phase, an amount of C18:0 (stearic acid) from 5 to 25 wt. %.

### FIELD OF THE INVENTION

The present invention relates to edible fat-containing products comprising an aqueous phase and 20-40 wt. % of a fat phase, such as very low fat spreads, and methods for their preparation.

### BACKGROUND OF THE INVENTION

Similar to butter, margarine must have a fat content of 80% or more. Spreads on the other hand are low fat (thus less than 80% fat) equivalents of margarine. Low fat spreads contain about 20-45% fat. Very low fat spreads are spreads with a fat content of 40% or less.

Spreads are water-in-oil (w/o) emulsions which typically contain blends of structuring fats or solid fats and oil (often vegetable oil). The structuring or solid fats provide the structure and texture to the resulting emulsion by crystallisation of the triglycerides in the blend. Typically, structuring fats contain more saturated and longer-chain fatty acids. Vegetable oils typically contain more unsaturated fatty acids and are usually liquid at room temperature. In order to incorporate suitable amounts of fats and oils in spreads, blends are made from solid fats (structuring fats) and oils wherein the solid fat (also known in the art as hard stock) provides the structure to incorporate oil into the emulsion.

For an edible fat-containing emulsion such as a spread, ideally the structuring fat has such properties that it melts or dissolves at mouth temperature. Otherwise the product may have a heavy and/or waxy mouthfeel. An important indicator is the temperature at which a spread breaks up in the mouth. Preferably this ‘break up temperature’ is below the in-mouth temperature. Furthermore, the overall organoleptic impression should be smooth and preferable no perceivable grains should be present upon ingestion as this may result in what is generally known as a ‘sandy mouthfeel’.

Other important aspects of an edible fat-continuous spread are for example hardness, spreadability, storage stability and ability to withstand temperature cycling. Temperature cycling means that the product is subjected to low and high temperatures (e.g. when the consumer takes the product out of the refrigerator and leaves it for some time at the table prior to use). This may have a negative influence on the structure of the spread (like for example destabilization of the emulsion, oil-exudation or crystal growth).

Generally, spreads are prepared according to known processes that encompass the following steps:
1. Mixing of the liquid oil, the structuring fat and the aqueous phase at a temperature at which the structuring fat is liquid;
2. cooling of the mixture under high shear to induce crystallization of the structuring fat to create an emulsion;
3. formation of a fat crystal network to stabilize the resulting emulsion and give the product some degree of firmness;
4. modification of the crystal network to produce the desired firmness, confer plasticity and reduce the water droplet size.

These steps are usually conducted in a process that involves an apparatus that allows heating, cooling and mechanical working of the ingredients, such as the chum process or the votator process. The chum process and the votator process are described in the Ullmans Encyclopaedia, Fifth Edition, Volume A 16, pages 156-158. The choice of fats that can practically be used as structuring agent may be limited. If the melting point of the structuring agent is too high, the melting properties in the mouth are unsatisfactory. If on the other hand, the melting point is too low, the emulsion stability will be negatively affected.

A major source of structuring fats is palm oil-based. The use of palm oil, high in saturated C16 (C16:0, palmitic acid) or enriched fractions thereof lies under scrutiny in view of the environmental demand that palm oil exerts. Hence there is a desire to use less palm oil based ingredients and the desire for using other sources of vegetable fats for structuring fats increases. Examples are the use of other plant-based fats like shea. It is an objective of the present invention to provide very low fat spreads that do not comprise palm oil-based ingredients.

In general, a structuring fat has a high content of saturated fatty acids. Conventional palm oil-based structuring fats or hard stocks have a high saturated content such as in the form of POP (palmitic-oleic-palmitic), PPO (palmitic-palmitic-oleic) or SOS (stearic-oleic-stearic) triglycerides. Structuring fats having a high content of these saturated triglycerides suffer from what is known in the art as graininess or sandiness, an unpleasant mouthfeel and appearance. The effect is attributed to the formation of fat crystals. Furthermore, SSS (tristearic acid glyceride) triglycerides are also seen as cumbersome as in food applications in view of a waxy mouthfeel. Products that express these effects generally experience a lower consumer acceptance level. It is a further objective of the present invention to provide very low fat spreads comprising triglyceride fats that have a relative low level of POP, PPO, SOS and/or SSS to avoid the disadvantages thereof or ameliorate the effects thereof. More generally, it is an objective of the present invention to provide very low fat spreads with comparable, and preferably improved palatability compared to prior art spreads. It is especially an objective of the present invention to provide very low fat spreads with a favourable taste and/or intense experience of salt.

Hydrogenation is a process of hardening fats and oils by converting unsaturated fatty acids in fats and oils to saturated fats. Hardening of fats is an efficient way of improving the structuring properties of fat and oils. Hydrogenation is perceived by consumers as a non-natural way of adapting fat compositions. Hydrogenation of fats to improve the structure of the resulting fat is less preferred as consumers are increasingly focused on having products that have a more natural origin. Incomplete or partial hydrogenation also results in products having increased levels of trans-fatty acids. Trans-fatty acids are considered less desirable in view of health considerations. It is an objective of the present invention to pride very low fat spreads with a low level of trans fatty acids.

Furthermore, there is also a desire to reduce the relative amount of saturated fatty acids in spreads in favour of unsaturated fatty acids in view of general healthcare issues attributed to diets high in saturated fats. It is thus a further objective of the present invention to provide very low fat spreads with a low level of saturated fatty acids.

Furthermore, while hard fats are necessary in order to provide structure to spreads, they require effort and resources to produce, unlike natural oils which can be used without extensive further processing. It is therefore a further objective of the present invention to provide very low fat spreads with a low amount of hard fat in order to produce the spreads in an environmentally friendly and cost efficient fashion.

Finally, especially for very low fat spreads, achieving a stable emulsion is challenging. The high amount of water and low amount of structuring fat renders it difficult to provide sufficient stability. Often strong emulsifiers are used and/or thickening agents to produce a product that at least has a droplet size (D3,3) and distribution value (e-sigma) that is in an acceptable range at the point of production and maintains an acceptable value over time (i.e. stability). Altering one or more of the combination of the structure providing components (structuring fat, thickener, emulsifier) is hence a challenge for the skilled person.

It is therefore a further objective of the present invention to provide very low fat spreads which are stable.

### SUMMARY OF THE INVENTION

Thereto, the present invention provides an edible fat-containing product comprising an aqueous phase and 20-40 wt. % of a fat phase, wt. % calculated on the total weight of product, wherein the fat phase comprises a liquid vegetable oil and 5-90 wt. % of a structuring fat, wt. % calculated on the fat phase, wherein the structuring fat is an interesterified blend of fats wherein one of the fats in the blend to be interesterified has >95 wt. % C18:0 calculated on the amount of fatty acids of the triglycerides of the fat, wherein the fats in the blend to be interesterified do not contain palm oil or palm oil-derived fractions, hydrogenated oil or fat or fractions thereof, wherein the liquid vegetable oil does not contain hydrogenated oil or fat or fractions thereof, and wherein the fat phase comprises, calculated on the amount fatty acids of the triglycerides of the fat phase, an amount of C18:0 (stearic acid) from 5 to 25 wt. %.

As the fats in the blend to be interesterified do not contain palm oil or palm oil-derived fractions, the structuring fat does not contain palm oil or palm oil-derived fractions (not more than 2 wt. % on the fat phase). As the fats in the blend to be interesterified do not contain hydrogenated oil or fat of fractions thereof, the structuring fat does not contain hydrogenated oil or fat of fractions thereof (not more than 2 wt. % on the fat phase). Preferably, the fat phase does not contain hydrogenated oil or fat or fractions thereof (not more than 2 wt % on the fat phase). Preferably, the fat phase does not contain palm oil or palm oil-derived fractions (not more than 2 wt. % on the fat phase).

The edible fat-containing product according to the invention comprises 20-40 wt. % of a fat phase, the remainder of the product is an aqueous phase up to 100 wt. %, wherein the weight percentages are based on the total weight of the product.

The products of the present invention differ from known product in a different composition in terms of fatty acids (high in C18:0, preferably low in C16:0) and further in that the products do not contain palm oil or palm oil-derived fractions. Palm oil or palm oil-derived fractions are usually the components that provide long chain saturated fatty acids to edible fat-containing products. The fat products of the present invention also preferably do not contain other plant-derived triglycerides that are capable of providing high amounts of saturated fatty acids such as fat (fractions) derived from shea, allanblackia or (interesterified) blends thereof.

The invention further provides a method for the preparation of the edible fat-containing product, the method comprising the steps of
providing the aqueous phase;
   providing the fat phase comprising the liquid oil and the structuring fat, preferably in liquid from; and
   mixing at least part of the fat phase with at least part of the aqueous phase to obtain a pre-mix;
   processing the premix, preferably in a margarin unit, to obtain the edible fat-containing product.

The present inventors have found that novel structuring fats can be used in edible fat containing products, such as very low fat spreads. These structuring fats have a higher content of saturated long chain (H) fatty acids, preferably stearic acid (S), as compared to palm-oil based structuring fats. An advantage is that lower amounts of structuring fats are needed and more liquid oil can be used in the preparation of applications for spreads. This improves the naturalness of the resulting product, improves nutritional value and also reduces cost, the latter being a relevant factor in this field.

Moreover, while the amount of the novel structuring fats in the very low fat spreads can be lower than the amount of palm-based structuring fat in conventional (palm-based) spreads, structural similarity is maintained. Also stability remains within acceptable values. Inventors have thus found a different structuring fat that can be used in even lower amounts without having to adapt the entire formulation (like emulsifiers or thickeners) in order to maintain stability, droplet size, stevens value and other relevant parameters. Furthermore, because the fat blends containing these structuring fats can incorporate more liquid oil than conventional (palm-oil and palm oil-derivative containing) products, the spreads can contain a lower amount of saturated fatty acids compared to conventional (palm-oil and palm oil-derivative containing) products.

The inventors have also found that very low fat spreads containing the novel structuring fats have a comparable mouthfeel with respect to palm-based products, while surprisingly having better taste, especially with respect to overall taste intensity and saltiness. The more intense experience of salt compared to conventional products may allow reduction of salt while maintaining taste. Reduction of salt in a diet is generally seen as a health benefit.

The present inventors have furthermore found that newly developed structuring fats having a high content of long-chain saturated fatty acids (H), such as S, stearic acid (and/or in some cases a lower P, palmitic acid level), especially at the 2-position of the triglyceride backbone provide for fat blends and products that meet the above criteria and result in edible fat-containing products such as spreads. The spreads can therefore have improved (lower) level of trans fatty acids, and can be made from non-palm and non-hydrogenated fats and oils. It was found that fats having a relative higher content of S and/or P (and a lower content of unsaturated fatty acids) in the 2-position of the glycerol backbone compared to conventional palm-based hard stock fats, lead to fat blends that, in spite of a different composition, can be processed under conventional processing conditions, yet lead to stable spreads that have good organoleptic properties, taste and texture.

The fat phase comprises an amount of C18:0 (stearic acid) from 5 to 25 wt. %. Without being bound by theory, it is believed that the improved structuring effects of the structuring fat and hence on the products formulated therewith, may predominantly be provided by an increase of the C18:0 level (higher) versus the C16:0 level (lower) compared to conventional products.

Preferably, the fat-containing product is a water-in-oil emulsion, and preferably, the edible fat-containing product is a spread.

Preferably, the fat-containing product comprises 20-less than 30 wt. % of the fat phase.

Preferably, the fat-containing product comprises 0.01-1 wt. % of polyglycerol polyricinoleate (PGPR), wt. % calculated on the weight of the product.

Preferably, the fat-containing product comprises at least 10 wt. % of the fat phase.

Preferably, the fat phase comprises from 20 to 60 wt. % of the structuring fat.

Preferably, the fat phase comprises an amount of C18:0 (stearic acid) from 5 to 15 wt. %.

Preferably, the fat phase comprises, calculated on the total amount of fatty acids of the triglycerides in the fat phase, an amount of C16:0 (palmitic acid) of less than 15 wt. %.

Preferably, the fat phase comprises an amount of C18:0 (stearic acid) at the 2-position of the glycerol backbone (2-C18:0) of more than 5 wt. %, calculated on the total amount of fatty acids on the 2-position of the glycerol backbone.

Preferably, the structuring fat comprises, calculated on the total amount of structuring fat, an amount of C18:0 (stearic acid) from 5 to 60 wt. %.

Preferably, the structuring fat comprises, calculated on the total amount of structuring fat, an amount of C16:0 (palmitic acid) of less than 25 wt. %.

Preferably, the structuring fat comprises an amount of C18:0 (stearic acid) at the 2-position of the glycerol backbone (2-C18:0) from 5 to 60 wt. %, calculated on the total amount of fatty acids on the 2-position of the glycerol backbone of the structuring fat.

In an embodiment, the fat-containing product is an emulsion comprising of 20 up to less than 30 wt. % of a fat phase, wt. % calculated on the amount of product, wherein the fat phase comprises a liquid vegetable oil and from 20 to 60 wt. % of a structuring fat, wt. % calculated on the fat phase, and wherein the fat phase comprises, calculated on the amount of the fat phase, an amount of C18:0 (stearic acid) from 5 to 15 wt %.

Further preferred features are given in the paragraphs at the end of the description.

### Definitions

The edible fat-containing products of the invention are spreads, in particular very low fat spreads, i.e. spreads with a fat content of 20-40 wt. %. Spreads are generally sold in tubs and are suitable as butter replacements.

The term “oil” or “liquid oil” is typically used for triglyceride compositions that that are liquid at room temperature. The term “liquid oil” is used for triglycerides that are liquid at room temperature, preferably also liquid at temperature below room temperature such as below 15, 10 or 5° C. Preferably the solid fat content of the liquid oil is 0 at 20° C., more preferably it is 0 at 15° C.

The term “fat”, is typically used for triglyceride compositions that that are solid at room temperature. The use of the term “oil” or “fat” is hence interchangeable depending on the circumstances that are clear and known in the art. A fat is typically used for structuring a fat composition, i.e. to provide a structure and texture in admixture with an oil or other fat. It can also be indicated as a structuring fat or hard stock fat. The fat may comprise two or more different hard fats (a blend), but is preferably a single fat. The fat may be an interesterified mixture of one or more fats.

“Fat-containing product” is herein understood as a product containing a fat and/or oil. The terms “fat” and “oil” are used interchangeably. In general a “fat” is solid at standard ambient temperature and pressure and an oil is liquid under these conditions. An “aqueous phase” is water and optionally any compounds that dissolve in water, whereas a “fat phase” encompasses any edible oil or fat and optionally any compounds that dissolve in oil or fat.

A “margarine fat” is a fat blend which is suitable for use as a fat in spreads, both fat-continuous and water-continuous. Such a margarine fat usually includes a fat and a liquid oil.

The fat fraction can also be characterized by a triacylglyceride or TAG profile. In the TAG profile and throughout this application, the following abbreviations can be used:

| | |
|---|---|
| M | Medium chain fatty acid (C12-C14) |
| H | Saturated long chain fatty acid >= C16 |
| P | Palmitic acid, C16:0 |
| S | Stearic acid, C18:0 |
| U | Unsaturated fatty acid |
| O | Oleic acid C18:1 |
| L | Linoleic acid/linolenic acid, C18:2, C18:3 |
| St | Saturated fatty acid |
| StStSt | Trisaturated glyceride |
| StU2 | Monosaturated triglyceride |
| StUSt | Symmetrical saturated triglyceride |
| St2U | Disaturated triglyceride |
| HUH | Symmetrical long chain triglyceride |
| H2U | Disaturated long chain triglyceride |
| HU2 | Monosaturated long chain triglyceride |
| U3 | Unsaturated triglyceride |
| H3 | Long chain saturated fatty acid triglyceride |
| H2M | Mixed (2 long, 1 medium) chain fatty acid triglyceride |
| M3 | Medium chain fatty acid triglyceride |
| Sh | Short chain fatty acid (C4-C10) |
| X | Any fatty acid (H, U or Sh) |
| SAFA | Saturated fatty acids |
| MUFA | Mono unsaturated fatty acids |
| PUFA | Poly unsaturated fatty acids |

In this specification all parts, proportions and percentages are by weight. The amount of fatty acids in an oil, fat or blend is based on the total amount of fatty acids in the oil, fat or blend. The amount of fat in a fat composition is based on the total weight of the fat composition. The amount of fat in a fat-containing product is based on the total weight of the fat-containing product. The amount of fatty acids in an oil, fat or blend at a specific position of the glycerol backbone is based on the total amount of fatty acids at the specific position of the glycerol backbone in the oil, fat or blend, unless otherwise stated.

The solid fat content (SFC) in this description and claims is expressed as N-value, essentially as defined in Fette, Seifen Anstrichmittel 80 180-186 (1978). The stabilisation profile applied is heating to a temperature of 80° C., keeping the oil for at least 10 minutes at 60° C. or higher, keeping the oil for 16 hours at 0° C. and then 30 minutes at the measuring temperature, except where indicated otherwise.

Non-hydrogenated means that the fat or oil has not undergone hydrogenation treatment. This entails the fats as well as blends and interesterified mixtures of the fats. Non-hydrogenated fats have essentially no trans-fatty acids. Preferably the fat of the invention has less than 5 wt. %, preferably less than 2 wt. %, of trans fatty acids, more preferably less than 1 wt. %, 0.5 wt. %, 0.1 wt. % or even 0 wt. % (non-detectable using analysis methods common in the art).

Conventionally partially hardened fat typically has as one of its disadvantages a relative high level of trans fat. Conventionally partially hardened fats are made by partial hydrogenation of an oil, typically a highly unsaturated oil. A highly unsaturated oil, such as sunflower oil, contains a high amount of unsaturated fatty acids (typically more than 90%), also at the 2-position. Partial hardening through hydrogenation is known to lead to the formation of trans-fatty acids, also at the 2-position. The structuring fat of the invention is obtained by transesterification or glycerolysis with saturated free fatty acids. This avoids trans-fat formation and leads to a fat that has an inherently lower trans-fat level, also on the 2-position.

In the known highly saturated fats, the fat has appeared to crystallize as coarse grains, which are unacceptable for a spread which ought to possess a smooth appearance and mouthfeel. Such effect is known in the art as sandiness or graininess.

In the case of sandiness, the particles have higher melting points, they do not melt so readily when rubbing them between the fingers. The well-known graininess consists of particles which also melt at relatively low temperature but the particle sizes are much smaller. It is known in the art that such effects are caused by fats that contain POP an PPO and in certain ratio's. By increasing the level of stearic acid overall, especially at the 2-position of the triglycerides of the structuring fat, and/or reducing the level of palmitic acid overall, and especially at the 2-position, the presence of POP, PPO and SOS is reduced. The resulting fat blend and edible fat containing products of the invention thus avoid or reduce the risk of sandiness or graininess. This is determinable for instance by mouthfeel or by microscopy. At the same time due to the presence of a certain amount of unsaturation, the waxiness mouthfeel known from other fats that are highly saturated such as SSS or fully saturated sunflower oil (SF69) can be avoided.

Interesterification and transesterification are methods for adapting the fatty acid composition of a fat composition.

Interesterification as used in the present disclosure and distinguished in the present disclosure from transesterification, refers to the exchange of fatty acids between triglycerides in a triglyceride mixture. In interesterification, the total fatty acid composition of the triglyceride mixture remains substantially the same, yet the distribution of the fatty acids over the glycerol backbone may be different. Interesterification typically results in a redistribution of the fatty acids over the glycerol backbone. Interesterification in the present invention can be catalytical, chemical or enzymatically. Methods therefore are known in the art and described herein.

Transesterification, as used in the present disclosure and distinguished in the present disclosure from interesterification, refers to the exchange of fatty acids between fatty acids (or fatty acid esters) and triglycerides. In transesterification, the total fatty acid composition of the triglyceride mixture changes. Transesterification results in a different fatty acid composition of the triglyceride mixture.

When a range is given, the range is meant to include both values, unless specifically indicated otherwise. Thus, unless indicated otherwise, a range of “10-30” also written as a range of “from 10 to 30” includes the value of 10 as well as 30. A range of “10 up to but not including 30” also written as “10 to less than 30” on the other hand specifically excludes the value of 30 from the range. Thus, an amount of “less than 30” also specifically excludes the value of 30. A value of “at least 10” includes the value of 10, whereas a value of “more than 10” excludes the value of 10.

### Fats and Oils

The fat phase is an essential element of the edible fat-containing product of the invention. Such a fat phase typically comprises edible fats and oils. There is a strong preference for non-hydrogenated fats and oils. Non-hydrogenated means that the fat or oil has not undergone any hydrogenation treatment. Preferably, the oils and fats in the fat phase contain at most 0.01 wt % hydrogenated fat (wt % drawn on the total fat phase), preferably no hydrogenated fat. This entails the starting fats and oils as well as blends and interesterified mixtures and even fractions of fats. Non-hydrogenated fats have essentially no trans-fatty acids.

The fat phase preferably comprises a sufficient amount of solid fat at low temperatures in order to yield a desired composition. Simultaneously, in order to instill desirable organoleptic properties in terms of mouthfeel and appearance, the fat phase preferably essentially melts in the mouth upon consumption.

### Sources of Fat and Oils

A suitable fat phase may be derived from many different fat sources. The fat phase of the product according to the present invention preferably comprises vegetable oil or vegetable fat or a combination thereof. It is preferred that the fat phase consists of vegetable oils and fats. The vegetable fats or oils may suitably be derived from coconut oil, rapeseed oil, linseed oil, soy bean oil, maize oil, sunflower oil, or mixtures thereof. The fat phase of a product according to the invention may comprise a liquid oil fraction and a (solid) structuring fat.

### Liquid Oil Fraction

The fat phase may comprise from 0 (absent) up to 99 wt. % of liquid oil, drawn on the fat phase. The liquid oil fraction can be an element of the fat phase of the fat-containing product of the invention.

The liquid oil fraction can be selected from the group consisting of rapeseed oil, linseed oil, soy bean oil, maize oil, sunflower oil, or mixtures thereof, preferably selected from the group consisting of rapeseed oil, sunflower oil, linseed oil and mixtures thereof.

### Structuring Fat

The structuring fat is an element of the fat phase of the edible composition. The fat phase comprises from 5 to 90 wt. % of structuring fat (wt. % calculated on the total weight of the fat phase), and preferably from 20 to 60 wt. %. The structuring fat used in the present invention is preferably an interesterified blend of fats wherein one of the fats in the blend (commonly indicated herein as the feedstock or FS) that is interesterified has a very high C18:0 content (>95 wt. % of the fatty acids are C18:0) and/or very low C16:0 content (<10 wt. % of the fatty acids are C16:0). This can be interesterified with another fat (such as coconut oil, shea and/or other vegetable oils) that can provide mid-range fatty acids such as C12:0 and C14:0. The advantage associated with the use of a first fat (feedstock) that is relative low in C16:0 and relative high in C18:0 is believed to reside in the increased capability of C18:0 of forming a structuring scaffold wherein the second fat that is interesterified with the feed stock to form the structuring fat can contain a higher amount of mid-range fatty acids to form the structuring fat to be used in fat blends of the spreads of the invention. This is thought to lead to increased cycling stability of the resulting fat blends and/or the need for less structuring fat (and more oil) in the blend while still achieving the desired spread properties.

Typically, the structuring fat used contains from about 5 to 60 wt. % of C18:0. The structuring fat may further contain between 2 to 25 wt. % of C16:0. Preferably, the fats in the blend of fats to be interesterified are non-hydrogenated and/or non-fractionated. Preferably, the fat to be interesterified with the feed stock is a natural fat, more preferably a non-fractionated natural fat.

### Products

Fat-containing products can be characterized by their N-line, the amount of solid fat at a certain temperature (e.g. N5(%) is the percentage of solid fat at 5° C.) as measured by NMR, to characterise the melting behaviour. Typically, spreads can be characterized by a an N-line as provided herein below. Typical fat phases can be characterized by solid fat content (SFC):

| | N5 (%) | N10 (%) | N20 (%) | N35 (%) |
|---|---|---|---|---|
| Spread product (w/o) | 10-50 | 8-40 | 4-20 | 0-3 |

In a preferred embodiment the low fat spread, preferably as a w/o emulsion, has a fat phase with an N-line of N5 12-40%, N10 9-30%, N20 4-20% and an N35 of <2.

The fat-containing product according to the invention may contain other ingredients as well, such as emulsifiers, flavoring agents, coloring agents, salt, preservatives, etc.

Preferably, the fat-containing product comprises an emulsifier. The emulsifier may be a mixture of one or more emulsifiers. The emulsifier is preferably added in an amount ranging from 0.01 wt. % to 4.0 wt. %, preferably 0.02 wt. % to 3.0 wt. %, more preferably 0.05 wt % to 2.0 wt %, even more preferably 0.05 to 1.0 wt %, most preferably 0.1 to 0.6 wt. %, based on the amount of the fat containing product.

The emulsifier is preferably an emulsifier with an HLB value of at most 7. In embodiments, the emulsifier has a HLB-value of at most 6. In embodiments, the emulsifier has a HLB-value of at most 5. In embodiments, the emulsifier has a HLB-value of at most 4.

In embodiments, the emulsifier has a HLB-value of at most 3. In embodiments, the emulsifier has a HLB-value of at least 1. In embodiments, the emulsifier has a HLB-value of at least 2. In embodiments, the emulsifier has a HLB-value of at least 3. In embodiments, the emulsifier has a HLB-value of at least 4. In embodiments, the emulsifier has a HLB-value ranging from 1 to 7. More preferably the emulsifier has a HLB-value ranging from 2 to 6, or ranging from 3 to 5.

Emulsifiers that may be used in this invention are for instance sucrose ethers and esters of fatty acids and fatty alcohols, sorbitan mono and di-esters of fatty acids and fatty alcohols, polyoxyethylenesorbitol esters of fatty acids, (partial) polyhydroxy esters of fatty acids from sugar alcohols and C8-C22 fatty acid alkyl esters, (propylene) (poly)glycol esters of fatty acids and fatty alcohols, (poly)ethoxylated fatty alcohols, lecithins, PGPR.

Preferred emulsifiers include the sucrose fatty acid esters. These are compounds which are esters of sucrose and one or more fatty acids. Sucrose esters of fatty acids can be obtained by esterifying one or more of the hydroxyl group of a sucrose molecule with fatty acids. The fatty acids react with one or more hydroxyl groups to form mono, di, tri or multi-fatty acid ester, or mixtures thereof. As sucrose has 8 hydroxyl groups, the maximum number of fatty acids that is esterified to one sucrose molecule is eight, to form sucrose octa fatty acid ester. Preferably the sucrose fatty acid ester comprises a mixed ester or homo-ester. Suitable fatty acids may vary both in alkyl chain length and in degree of unsaturation. The fatty acid is preferably selected from the group consisting of lauric acid, myristic acid, palmitic acid, stearic acid and mixtures thereof.

Sucrose fatty acid esters can also be mixtures of different compounds, meaning having a different degree of substitution or a mixture of different types of fatty acids, or both. Sucrose esters are available with a wide range of HLB values which are controlled by the degree of esterification and the type of fatty acid used.

Another type of preferred emulsifier is the sorbitan fatty acid esters. These are esters of sorbitan and one or more fatty acids, with a variation in type of fatty acids and number of fatty acid residues per sorbitan moiety, leading to a variety of HLB values.

Preferably the emulsifier comprises a monoglyceride of a fatty acid. A monoglyceride of a fatty acid is a common emulsifier, which is prepared by reacting glycerol with a vegetable oil or with fatty acids. The type of vegetable oil, the degree of saturation of the fatty acids, and the type of fatty acids influence their properties.

Preferably, where the emulsifiers contain fatty acid residues, these are not prepared or derived from palm oil or palm oil derivatives.

Preferably the emulsifier additionally comprises lecithin. Lecithin is a general term for a substance from animal or plant origin, containing phospholipids. The most abundant phospholipids are phosphatidylcholine (PC), phosphatidylethanolamine (PE), phosphatidylinositol (PI), phosphatidic acid (PA). Generally the amount of phospholipids in lecithin ranges from about 40% to about 50%. Other compounds in lecithin are generally triglycerides, glycolipids, and complexed sugars. In the context of the present invention, when referring to the concentration of emulsifier in the oil, the entire mixture of lecithin is meant, not only the phospholipids. The most abundant sources of lecithin used in foods are oil crops and oil seeds, and chicken eggs. The lecithin preferably originates from soyabean, sunflower seed, rapeseed, or egg, or from any combination of these.

Possible emulsifiers are Glycol Distearate, Sorbitan Trioleate, Propylene Glycol Isostearate Glycol Stearate Sorbitan Sesquioleate, Glyceryl Stearate, Lecithin, Sorbitan Oleate, Sorbitan Monostearate, Sorbitan Stearate, Sorbitan Isostearate, Steareth-2, Oleth-2, Glyceryl Laurate, Ceteth-2, PEG-30 Dipolyhydroxystearate, Glyceryl Stearate, Sorbitan Stearate Sucrose Cocoate, PEG-4 Dilaurate, Methyl Glucose Sesquistearate, PGPR.

Emulsifiers may also be selected from natural mono- and diglycerides, citric acid, lecithin, polyglycerol polyricinoleate (PGPR), eggs, carrageenan, guar gum, mustard, or combinations thereof. Synthetic esters of mono- and diglycerides are not preferred.

The emulsifier is most preferably PGPR (E476).

### EXAMPLES

The invention is illustrated by the non-limiting examples and comparative examples described below.

### Characterization of the Starting Components and Products

The products resulting from the interesterification were analysed using the following analytical methods:

### FA Analysis

For starting fat or fat-containing products, the overall fatty acid analysis and the triglyceride composition are determined using conventional procedures in the art such as FAME analysis, GLC/Carbon number method and HPLC silver phase method such as described for example in EP78568, EP652289, JOACS (19914), 68(5), 289-293 and Hammond E. W. J., Chromatography, 203, 397, 1981.

### Solid Fat Content (SFC) Measurements

The solid fat content (SFC) in this description and claims is expressed as the N-value, as defined in Fette, Seifen Anstrichmittel 80 180-186 (1978). The N-Value gives the percentage of fat which is solid or in the crystallised form at a given temperature. For example, N20=35 indicates that 35% of the fat is in crystallised form at 20° C. (the amount of solids at that temperature).

The stabilization profile applied is heating to a temperature of 80 degrees Celsius, keeping the oil for at least 10 minutes at 60 degrees Celsius or higher, keeping the oil for 1 hour at 0 degrees Celsius and then 30 minutes at the measuring temperature (tempered). An alternative method is described in IUPAC 2.150 method, serial, non-tempered.

### 2—Position Analysis

The method is based on the Joint JOCS/AOCS Official Method Ch 3a-19 (2019). This method provides a procedure for the determination of the composition of fatty acids which are esterified at the sn-2 position (ß (beta) or internal position) of the triacylglycerol molecules in animal and vegetable fats and oils. The method is comprised of the 1(3)-position selective transesterification of the triacylglycerols with ethanol by Candida antarctica lipase to yield 2-monoacylglycerols, followed by the separation of the 2-monoacylglycerols by silica-gel chromatography, and determination of their fatty acid composition by gas chromatography.

### Water Droplet Size Distribution of Spreads (D3.3 Measurement)

The normal terminology for Nuclear Magnetic Resonance (NMR) is used throughout this method. On the basis of this method the parameters D3,3 and exp(σ) of a lognormal water droplet size distribution can be determined. The D3,3 is the volume weighted mean droplet diameter and a is the standard deviation of the logarithm of the droplet diameter. A D3,3<27, is acceptable for a freshly produced low fat spread, but a D3,3<25 is preferred. A e-sigma of <4 is desired.

The NMR signal (echo height) of the protons of the water in a water-in-oil emulsion are measured using a sequence of 4 radio frequency pulses in the presence (echo height E) and absence (echo height E*) of two magnetic field gradient pulses as a function of the gradient power. The oil protons are suppressed in the first part of the sequence by a relaxation filter. The ratio (R=E/E*) reflects the extent of restriction of the translational mobility of the water molecules in the water droplets and thereby is a measure of the water droplet size. By a mathematical procedure—which uses the log-normal droplet size distribution—the parameters of the water droplet size distribution D3,3 (volume weighed geometric mean diameter) and a (distribution width) are calculated. A Bruker magnet with a field of 0.47 Tesla (20 MHz proton frequency) with an air gap of 25 mm is used (NMR Spectrometer Bruker Minispec MQ20 Grad, ex Bruker Optik GmbH, DE).

### Spreadability

Spreadability is determined according to the following protocol.

A flexible palette knife is used to spread a small amount of the spread on to fat free paper.

The spreading screen is evaluated according to standardized scaling. A score of 1 represents a homogeneous and smooth product without any defects, a 2 refers to the same product but then with small remarks as slightly inhomogeneous or some vacuoles, a 3 refers to the level where defects become almost unacceptable, like loose moisture or coarseness during spreading. A score of 4 or 5 refers to unacceptable products, where the 4 refers to a product still having some spreading properties, but an unacceptable level of defects.

### Free Water

After spreading a sample of a fat spread, the stability of the emulsion after spreading is determined by using indicator paper (Wator, ref 906 10, ex Machery-Nagel, DE) which develops dark spots where free water is adsorbed. A stable product does not release any water and the paper does not change. Very unstable products release free water easily and this is indicated by dark spots on the paper.

A six point scale is used to quantify the quality of fat spread (DIN 10 311):
0 (zero) is a very stable and good product;
1 (one) is showing some loose moisture (one or two spots, or the paper changes a little in color as a total);
2 (two) as one but more pronounced;
3 (three) as one but to an almost unacceptable level;
4 (four) indicator paper is almost fully changing into a darker color;
5 (five) the paper changes completely and very fast into the maximum level of color intensity.

Spreads with a score of 4 or 5 are rejected for their stability. Spreads with a score of 0 or 1 show an acceptable quality with respect to free water.

### Salt Release

The salt release is expressed as increasing of conductivity per degree Celsius. The salt release is measured with a conductivity meter type H14321 (HANNA) according the following protocol.

A sample hold cell type ESE4-10-50PAMA (FESTO) is filled with 1.5 gram of the sample (5 degrees Celsius). The cell is placed above a heating plate (having a temperature of 250 degrees Celsius). A glass beaker (Scott Duran) provided with magnetic stirrer [4×200 mm] is filled with 150 gram water (5 degrees Celsius) and placed on a heating plate (stirring speed 600 rpm). Simultaneously the software controlled measurement is started (Raak Lab Informatics BV). When the water has reached a temperature of 20 degrees Celsius the sample is pushed out of the sample hold cell into the beaker automatically and the conductivity versus temperature will be measured every second. When the content of the beaker reaches 75 degrees Celsius the measurement is stopped. The measurement is done in duplicate. The results are incorporated in a graph of temperature versus conductivity. From this graph the temperature at which the conductivity starts to increase rapidly, indicating release of salt from the sample, is determined. The temperature at which the conductivity has increased 41 micro-s from the baseline is defined as the salt release temperature.

Alternatively, salt release is determined by trained tasting panels.

### Preparation of a Spread

The fat phase and the aqueous phase were mixed and kept at 55-65 degrees Celsius. The mixture was then passed through a series of scraped surface heat exchangers (A-units) and stirred crystallisers (C-units) at various speeds. The product leaving the last unit had a temperature of below 20 and in some occasions below 5-7 degrees Celsius. The product was filled in tubs and stored at 5 degrees Celsius. A stable spread was obtained. Various products were prepared. The results are presented in Table 1.

### Materials

The ingredients used to prepare the fat-containing products are all commercially free available compounds and compositions.

### Feed Stock

A feed stock was obtained by reacting an excess of stearic acid with glycerol under increased pressure and temperature in a conventional way (24 hrs, 150-220 degrees Celsius, reduced pressure). After completion of the reaction, the excess stearic acid was removed by stripping to yield a fat with a C18:0 content of 96.4% and a CN54 of 90%. Data of the feedstock used are presented in Table 1.

### Hard Stock

The feedstock can be interesterified with other oils and fats (sunflower oil, coconut oil) to produce a hard stock (Example 1) that can be applied e.g. in margarine fat, margarine and spreads production. Conventional palm-based hard stock is presented as Comparative Example 1. Interesterification can executed by chemical interesterification (CIE) with a catalyst (NaOCH₃). Alternatively, hard stocks can be prepared by non-catalytic interesterification or by enzymatic interesterification. The ratio of the feedstock and the other oils and fats is selected to optimize the properties of the desired hard stock as an ingredient in a final spread.

### Chemical Interesterification Procedure (CIE)

The feed stock is blended with other oils and fats in an appropriate ratio as specified to come to the desired hard stock. An amount of NaOH (50% w/w solution in water) is added to ensure FFA of the blend is <0.05% before catalyst dosing. Once the oil is free of FFA, the oil is dried under vacuum to eliminate any residual water (<100 ppm as measured by Karl Fisher titration). The catalyst is added (0.1% w/w sodium methoxide) and the blend brought under vacuum (25 mbar). The reaction starts when the color of the blend darkens (red/brownish). Once the reaction is started, the reaction is continued for 30 minutes at 90° C. and 25 mbar. After completion of the reaction, the catalyst is inactivated by breaking the vacuum in the reactor and adding citric acid. The acid is dosed to ensure 20% molar excess vis-a-vis added catalyst. Citric acid is dosed as a 20% solution (w/w in water). The mixture is allowed to react for 15 minutes at 90° C. at atmospheric pressure. The CIE hard stock is post-treated: bleached and deodorized. The resulting hard stock is analysed for TAG profile, N-line, 2-position FA analysis.

### Bleaching

The oil is heated to 85° C. A stoichiometric amount of citric acid (30% solution) is dosed to acidulate soaps and the mixture reacted for 15 minutes at atmospheric pressure. The oil is heated to 100° C. under vacuum (50 mbar). Bleaching earth (1%—Tonsil 210FF or equivalent activated clay) is added. The slurry is agitated for 30 minutes, at 100° C. and 50 mbar. The bleaching earth is filtered off.

### Deodorization

The bleached oil is deodorized until FFA<0.05% (indicative parameters: 240° C.—3 mbar—0.5-1% stripping steam). Cool down to 80° C. followed by purging with nitrogen and storage of the hard stock in hermetically closed recipients.

### Emulsification

Fats and spreads are prepared by blending fats, oils and/or aqueous phases using conventional procedures such as described in handbooks like “Fats and Oils Handbook”, 1998, Michael Bockisch.

### Example 1 Hard Stock

Using the above general procedure for chemical interesterification, a mixture of 20 parts by weight feed stock, 25 parts by weight sunflower oil and 55 parts by weight of coconut oil (CN) are chemically interesterified. The results are presented in Table 1.

### Example 2 Low Fat Spread

A spread was prepared by blending the structuring fat of example 1 with rapeseed oil together with other (minor) ingredients and water to result in 100 part by weight of a product Example 2. Comparative example 2 was prepared using the same procedure with other components as specified in Table 2, using commercially available hard stock (50PO/10dfPOs/40PK (erES30, Comparative example 1) The compositions are described in Table 2.

TABLE 2

| | Ex. 2 | C. Ex 2 |
|---|---|---|
| Product | 28% spread | 28% spread |
| Ingredients | g per 100 g | g per 100 g |
| Rapeseed oil (RP) | 15.7 | 12.4 |
| Palm containing hard | | 15.1 |
| stock (erES30) Comp. Ex 1 | | |
| Hard stock example 1 | 11.8 | |
| Mono and diglycerides | 0.42 | 0.42 |
| of fatty acids | | |
| PGPR | 0.1 | 0.1 |
| Fat soluble minors | <0.1 | <0.1 |
| Water | 65.0 | 65.0 |
| Starch | 2.8 | 2.8 |
| Salt | 1.6 | 1.6 |
| Pork gelatine | 2 | 2 |
| Water soluble minors | 0.6 | 0.6 |
| SAFA | 35.1 | 38.2 |

Various properties related to taste, aftertaste, appearance, structure and mouthfeel were rated by experienced tasting panels. The comparative results of Example 3 versus Comparative Example 3 are given in Table 3. A “+” entry means Example 3 performed better, a “−” means Comparative Example 3 performed better. No entry indicates that there was no substantial difference.

TABLE 3

| | Ex. 3 versus C. Ex. 3 | Comparative rating |
|---|---|---|
| Taste | Overall taste intensity | + |
| | Salty | + |
| | Sour | |
| Aftertaste | Overall aftertaste intensity | |
| Appearance | Yellowness | |
| | Shininess | − |
| Structure | Spreadability on bread | − |
| | Smooth structure on bread | − |
| Mouthfeel | Firmness in mouth | + |
| | Fatty | |
| | Stickiness | |
| | Melting ability in mouth | − |
| | Homogenous texture when melting | |
| | Grainy | |

The results indicate that the composition of Example 3 has a better overall taste intensity and increased saltiness as compared to the Comparative Example, which only differs with respect to the used hard stock and ratio of hard stock vs. oil. Aftertaste and mouthfeel are comparable.

Stability tests were performed after 2 weeks at a temperature of 5° C. Droplet size, spreadability, free water, and a visual check were performed. The results are summarized in Table 4. The product of Example 2 expressed a good stability, and spreadability.

TABLE 4

| | | Ex. 2 | C. Ex. 2 |
|---|---|---|---|
| After 2 | D3, 3 | 19.1 | 18.4 |
| weeks | e-sigma | 2.9 | 2.99 |
| | Stevens S5 | 178 | 105 |
| | Spreadability | 3 | 3 |
| | Free Water | 2 | 1 |

*Stevens probe 4.4 mm

Further testing is performed after cycling and at 2, 4, 8, and 16 weeks, and the results recorded.

TABLE 1

| | | | | | Ex. 1 | C. Ex. 1 | Ex. 2 | C. Ex. 2 |
|---|---|---|---|---|---|---|---|---|
| | | | | | 20FS/ | 50PO/ | 28% fat: | 28% fat: |
| | | | | | 25SF/ | 10dfPOs/ | 43Ex1/ | 55C.Ex1/ |
| Fat Blend | CN | SF | RP | FS | 55CN | 40PK | 57RP | 45RP |
| FAC % | | | | | | | | |
| C8:0 | 7.3 | | | | 3.9 | 1.5 | 1.7 | 0.8 |
| C10:0 | 5.9 | | | | 3.2 | 1.4 | 1.4 | 0.8 |
| C12:0 | 45.1 | | | | 25.0 | 18.8 | 10.8 | 10.3 |
| C14:0 | 18.4 | | | | 10.3 | 7.2 | 4.4 | 4.0 |
| C16:0 | 9.7 | 6.7 | 4.3 | 0.9 | 8.8 | 31.0 | 6.2 | 19.0 |
| C18:0 | 3 | 4.9 | 1.7 | 96.4 | 20.5 | 3.7 | 9.8 | 2.8 |
| C18:1 | 7.3 | 20.7 | 63.3 | 0.4 | 12.9 | 28.4 | 41.6 | 44.1 |
| C18:2 | 2 | 66.7 | 20.1 | 0.1 | 13.5 | 6.7 | 17.3 | 12.7 |
| C18:3 | | | 9.8 | | 0.1 | 0.1 | 5.6 | 4.5 |
| C20:0 | 0.1 | 0.3 | 0.6 | 1.0 | 0.5 | 0.3 | 0.6 | 0.4 |
| C22:0 | | 0.7 | 0.3 | 0.5 | 0.4 | | 0.3 | 0.1 |
| SAFA | 89.5 | 12.55 | 6.8 | 98.8 | 72.6 | 63.9 | 35.1 | 38.2 |
| MUFA | 7.3 | 20.71 | 63.3 | 0.4 | 12.9 | 28.4 | 41.6 | 44.1 |
| PUFA | 2.0 | 66.7 | 29.9 | 0.1 | 13.6 | 6.8 | 22.9 | 17.2 |
| Total trans content (<) | 0.5 | 0.5 | | 0.5 | 0.5 | | 0.5 | 0.5 |
| H | 12.7 | 11.6 | 6.0 | 97.3 | 29.3 | 34.7 | 16.0 | 21.8 |
| M | 63.5 | 0.0 | 0.0 | 0.0 | 35.3 | 26.0 | 15.2 | 14.3 |
| U | 9.3 | 87.4 | 93.2 | 0.5 | 26.5 | 35.2 | 64.5 | 61.3 |
| N line % | | | | | | | | |
| N5 | 84.6 | | | 96.6 | 73.1 | 67.5 | 28.6 | |
| N10 | 78 | | | 96.4 | 66.3 | 60.2 | 21.7 | |
| N15 | 65.2 | | | 96.1 | 49.8 | 44.5 | 13.6 | |
| N20 | 37.7 | | | 95.7 | 35.3 | 30.9 | 6.7 | |
| N25 | 1.1 | | | 95.6 | 19.2 | 18.4 | 2.2 | |
| N30 | | | | 95.7 | 7.2 | 8.9 | 0.0 | |
| N35 | | | | 95.4 | 1.1 | 3.0 | 0.0 | |
| 2-position % | | | | | | | | |
| 2-C8:0 | | | | | 1.2 | 0.7 | 0.5 | 0.4 |
| 2-C10:0 | | | | | 2.5 | 1.1 | 1.1 | 0.6 |
| 2-C12:0 | | | | 0.2 | 25.2 | 21.4 | 10.8 | 11.8 |
| 2-C14:0 | | | | 0.1 | 11.1 | 7.1 | 4.8 | 3.9 |
| 2-C16:0 | | 0.4 | 0.3 | 1.3 | 9.9 | 21.0 | 4.4 | 11.7 |
| 2-C18:0 | | 0.3 | 0.1 | 95.8 | 23.2 | 2.1 | 10.0 | 1.2 |
| 2-C18:1 | | 19.7 | 53.7 | 0.6 | 13.0 | 37.4 | 36.2 | 44.7 |
| 2-C18:2 | | 79.7 | 31.3 | 0.4 | 12.8 | 9.0 | 23.3 | 19.0 |
| 2-C18:3 | | | 14.6 | | | 0.2 | 8.3 | 6.7 |
| 2-C20:0 | | | | 0.9 | 0.6 | | 0.3 | 0.0 |
| 2-C22:0 | | | | 0.4 | 0.4 | | 0.2 | 0.0 |
| 2-H (2-C16:0 + 2-C18:0) | | 0.7 | 0.3 | 97.1 | 33.1 | 23.1 | 14.4 | 12.8 |
| 2-C16:0/2-H | | 0.6 | 0.8 | 0.0 | 0.3 | 0.9 | 0.3 | 0.9 |
| 2-C18:0/2-H | | 0.4 | 0.2 | 1.0 | 0.7 | 0.1 | 0.7 | 0.1 |
| 2-U (C18:1 + C18:2 + C18:3) | | 99.4 | 99.6 | 1.0 | 25.8 | 46.6 | 67.9 | 70.5 |
| 2-H/2-U | | 0.0 | 0.0 | 97.1 | 1.3 | 0.5 | 0.2 | 0.2 |
| 2-C18:0/2-U | | 0.0 | 0.0 | 95.8 | 0.9 | 0.0 | 0.1 | 0.0 |
| 2-C16:0/2-U | | 0.0 | 0.0 | 1.3 | 0.4 | 0.5 | 0.1 | 0.3 |
| 2-C18:0/2-C16:0 | | 0.7 | 0.3 | 73.7 | 2.3 | 0.1 | 2.3 | 0.1 |
| 2-C16:0/total C16:0 | | 0.1 | 0.1 | 1.4 | 1.1 | 0.7 | 0.7 | 0.6 |
| 2-C18:0/total C18:0 | | 0.1 | 0.0 | 1.0 | 1.1 | 0.6 | 1.0 | 0.4 |
| 2-C16:0 + 2-C18:0/ | | 0.1 | 0.1 | 1.0 | 1.1 | 0.7 | 0.9 | 0.6 |
| (total C16:0 + total C18:0) | | | | | | | | |
| 2-SAFA | | 0.7 | 0.3 | 98.7 | 74.1 | 53.4 | | |
| 2-SAFA/Total SAFA | | 0.1 | 0.0 | 1.0 | 1.0 | 0.8 | | |

### Paragraphs

1. Edible fat-containing product comprising an aqueous phase and 20-40 wt. % of a fat phase, wt. % calculated on the total weight of product,
   wherein the fat phase comprises a liquid vegetable oil and 5-90 wt. % of a structuring fat, wt. % calculated on the fat phase,
   wherein the structuring fat is an interesterified blend of fats wherein one of the fats in the blend to be interesterified has >95 wt. % C18:0 calculated on the amount of fatty acids of the triglycerides of the fat,
   wherein the fats in the blend to be interesterified do not contain
      palm oil or palm oil-derived fractions,
      hydrogenated oil or fat or fractions thereof,
   wherein the liquid vegetable oil does not contain hydrogenated oil or fat or fractions thereof, and
   wherein the fat phase comprises, calculated on the amount fatty acids of the triglycerides of the fat phase, an amount of C18:0 (stearic acid) from 5 to 25 wt. %.
2. Edible fat-containing product according to paragraph 1, wherein the structuring fat does not contain hydrogenated oil or fat or fractions thereof.
3. Edible fat-containing product according to paragraph 1 or 2, wherein the fat phase does not contain hydrogenated oil or fat or fractions thereof.
4. Edible fat-containing product according to any one of the preceding paragraphs, wherein the fat-containing product is a water-in-oil emulsion.
5. Edible fat-containing product according to any one of the preceding paragraphs, wherein the fat-containing product is a spread.
6. Edible fat-containing product according to any one of the preceding paragraphs, wherein the structuring fat does not contain palm oil or palm oil-derived fractions
7. Edible fat-containing product according to any one of the preceding paragraphs, wherein the liquid vegetable oil does not contain palm oil or palm oil-derived fractions.
8. Edible fat-containing product according to any one of the preceding paragraphs, wherein the fat phase does not contain palm oil or palm oil-derived fractions.
9. Edible fat-containing product according to any one of the preceding paragraphs, wherein the fat phase does not contain more than 2 wt. % palm oil or palm oil-derived fractions.
10. Edible fat-containing product according to any one of the preceding paragraphs, wherein the fat-containing product comprises less than 40 wt. % of the fat phase.
11. Edible fat-containing product according to any one of the preceding paragraphs, wherein the fat-containing product comprises up to 39 wt. % of the fat phase.
12. Edible fat-containing product according to any one of the preceding paragraphs, wherein the fat-containing product comprises 20-39 wt % of the fat phase.
13. Edible fat-containing product according to any one of the preceding paragraphs, wherein the fat-containing product comprises at least 21 wt. % of the fat phase.
14. Edible fat-containing product according to any one of the preceding paragraphs, wherein the fat-containing product comprises at least 23 wt. % of the fat phase.
15. Edible fat-containing product according to any one of the preceding paragraphs, wherein the fat-containing product comprises at least 25 wt. % of the fat phase.
16. Edible fat-containing product according to any one of the preceding paragraphs, wherein the fat-containing product comprises more than 25 wt % of the fat phase.
17. Edible fat-containing product according to any one of the preceding paragraphs, wherein the fat-containing product comprises up to 29 wt. % of the fat phase.
18. Edible fat-containing product according to any one of the preceding paragraphs, wherein the fat-containing product comprises 25-29 wt. % of the fat phase.
19. Edible fat-containing product according to any one of the preceding paragraphs, wherein the fat-containing product comprises less than 29 wt % of the fat phase.
20. Edible fat-containing product according to any one of the preceding paragraphs, wherein the fat-containing product comprises at least 0.01 wt. % polyglycerol polyricinoleate (PGPR).
21. Edible fat-containing product according to any one of the preceding paragraphs, wherein the fat-containing product comprises 0.05-0.4 wt. % of PGPR.
22. Edible fat-containing product according to any one of the preceding paragraphs, wherein the fat-containing product comprises 0.1-0.4 wt. % of PGPR.
23. Edible fat-containing product according to any one of the preceding paragraphs, wherein the fat-containing product comprises 0.1-0.4 wt % of PGPR.
24. Edible fat-containing product according to any one of the preceding paragraphs, wherein the fat-containing product comprises 0.2-0.4 wt % of PGPR.
25. Edible fat-containing product according to any one of the preceding paragraphs, wherein the fat-containing product comprises at most 0.4 wt. % of PGPR.
26. Edible fat-containing product according to any one of the preceding paragraphs, wherein the fat phase comprises from 20 to 60 wt. % of the structuring fat.
27. Edible fat-containing product according to any one of the preceding paragraphs, wherein the fat phase comprises from 25 to 55 wt. % of the structuring fat.
28. Edible fat-containing product according to any one of the preceding paragraphs, wherein the fat phase comprises from 30 to 50 wt. % of the structuring fat.
29. Edible fat-containing product according to any one of the preceding paragraphs, wherein the fat phase comprises from 35 to 45 wt. % of the structuring fat.
30. Edible fat-containing product according to any one of the preceding paragraphs, wherein the fat phase comprises an amount of C18:0 (stearic acid) from 5 to 15 wt. %.
31. Edible fat-containing product according to any one of the preceding paragraphs, wherein the fat phase comprises an amount of C18:0 (stearic acid) of more than 5 wt. %.
32. Edible fat-containing product according to any one of the preceding paragraphs, wherein the fat phase comprises an amount of C18:0 (stearic acid) from 6 to 14 wt. %.
33. Edible fat-containing product according to any one of the preceding paragraphs, wherein the fat phase comprises an amount of C18:0 (stearic acid) of more than 6 wt. %.
34. Edible fat-containing product according to any one of the preceding paragraphs, wherein the fat phase comprises an amount of C18:0 (stearic acid) from 7 to 12 wt. %.
35. Edible fat-containing product according to any one of the preceding paragraphs, wherein the fat phase comprises an amount of C18:0 (stearic acid) of more than 7 wt. %.
36. Edible fat-containing product according to any one of the preceding paragraphs, wherein the fat phase comprises an amount of C18:0 (stearic acid) of more than 8 wt. %.
37. Edible fat-containing product according to any one of the preceding paragraphs, wherein the fat phase comprises an amount of C18:0 (stearic acid) of more than 9 wt. %.
38. Edible fat-containing product according to any one of the preceding paragraphs, wherein the fat phase comprises an amount of C18:0 (stearic acid) of more than 10 wt. %.
39. Edible fat-containing product according to any one of the preceding paragraphs, wherein the fat phase comprises, calculated on the total amount of fatty acids of the triglycerides in the fat phase, an amount of C16:0 (palmitic acid) of less than 15 wt %.
40. Edible fat-containing product according to any one of the preceding paragraphs, wherein the fat phase comprises an amount of C16:0 (palmitic acid) from 1 to 12 wt. %.
41. Edible fat-containing product according to any one of the preceding paragraphs, wherein the fat phase comprises an amount of C16:0 (palmitic acid) of less than 12 wt. %.
42. Edible fat-containing product according to any one of the preceding paragraphs, wherein the fat phase comprises an amount of C16:0 (palmitic acid) from 2 to 10 wt. %.
43. Edible fat-containing product according to any one of the preceding paragraphs, wherein the fat phase comprises an amount of C16:0 (palmitic acid) of less than 10 wt. %.
44. Edible fat-containing product according to any one of the preceding paragraphs, wherein the fat phase comprises an amount of C16:0 (palmitic acid) from 3 to 9 wt. %.
45. Edible fat-containing product according to any one of the preceding paragraphs, wherein the fat phase comprises an amount of C16:0 (palmitic acid) from 4 to 8 wt. %.
46. Edible fat-containing product according to any one of the preceding paragraphs, wherein the fat phase comprises an amount of C16:0 (palmitic acid) of less than 8 wt. %.
47. Edible fat-containing product according to any one of the preceding paragraphs, wherein the fat phase comprises an amount of C18:0 (stearic acid) at the 2-position of the glycerol backbone (2-C18:0) of more than 4 wt. %, calculated on the total amount of fatty acids on the 2-position of the glycerol backbone.
48. Edible fat-containing product according to any one of the preceding paragraphs, wherein the fat phase comprises an amount of 2-C18:0 (stearic acid) from 5 to 15 wt. %.
49. Edible fat-containing product according to any one of the preceding paragraphs, wherein the fat phase comprises an amount of 2-C18:0 (stearic acid) of more than 5 wt. %.
50. Edible fat-containing product according to any one of the preceding paragraphs, wherein the fat phase comprises an amount of 2-C18:0 (stearic acid) of from more than 5 up to 15 wt. %.
51. Edible fat-containing product according to any one of the preceding paragraphs, wherein the fat phase comprises an amount of C18:0 (stearic acid) at the 2-position of the glycerol backbone (2-C18:0) from 6 to 14 wt. %.
52. Edible fat-containing product according to any one of the preceding paragraphs, wherein the fat phase comprises an amount of 2-C18:0 (stearic acid) of more than 6 wt. %.
53. Edible fat-containing product according to any one of the preceding paragraphs, wherein the fat phase comprises an amount of C18:0 (stearic acid) at the 2-position of the glycerol backbone (2-C18:0) from 7 to 13 wt. %.
54. Edible fat-containing product according to any one of the preceding paragraphs, wherein the fat phase comprises an amount of 2-C18:0 (stearic acid) of more than 7 wt. %.
55. Edible fat-containing product according to any one of the preceding paragraphs, wherein the fat phase comprises an amount of 2-C18:0 (stearic acid) of more than 8 wt. %.
56. Edible fat-containing product according to any one of the preceding paragraphs, wherein the fat phase comprises an amount of C16:0 (palmitic acid) at the 2-position of the glycerol backbone (2-C16:0) of less than 10 wt. %, calculated on the total amount of fatty acids on the 2-position of the glycerol backbone.
57. Edible fat-containing product according to any one of the preceding paragraphs, wherein the fat phase comprises an amount of C16:0 (palmitic acid) at the 2-position of the glycerol backbone (2-C16:0) of less than 8 wt. %.
58. Edible fat-containing product according to any one of the preceding paragraphs, wherein the fat phase comprises an amount of C16:0 (palmitic acid) at the 2-position of the glycerol backbone (2-C16:0) from 0.1 to 7 wt %.
59. Edible fat-containing product according to any one of the preceding paragraphs, wherein the fat phase comprises an amount of C16:0 (palmitic acid) at the 2-position of the glycerol backbone (2-C16:0) of less than 7 wt. %.
60. Edible fat-containing product according to any one of the preceding paragraphs, wherein the fat phase comprises an amount of C16:0 (palmitic acid) at the 2-position of the glycerol backbone (2-C16:0) from 0.5 to 6 wt %.
61. Edible fat-containing product according to any one of the preceding paragraphs, wherein the fat phase comprises an amount of C16:0 (palmitic acid) at the 2-position of the glycerol backbone (2-C16:0) of less than 6 wt. %.
62. Edible fat-containing product according to any one of the preceding paragraphs, wherein the fat phase comprises an amount of C16:0 (palmitic acid) at the 2-position of the glycerol backbone (2-C16:0) from 1 to 5.5 wt %.
63. Edible fat-containing product according to any one of the preceding paragraphs, wherein the fat phase comprises an amount of C16:0 (palmitic acid) at the 2-position of the glycerol backbone (2-C16:0) of less than 5 wt. %.
64. Edible fat-containing product according to any one of the preceding paragraphs, wherein the structuring fat comprises, calculated on the total amount of structuring fat, an amount of C18:0 (stearic acid) from 5 to 60 wt. %.
65. Edible fat-containing product according to any one of the preceding paragraphs, wherein the structuring fat comprises an amount of C18:0 (stearic acid) of more than 5 wt. %.
66. Edible fat-containing product according to any one of the preceding paragraphs, wherein the structuring fat comprises an amount of C18:0 (stearic acid) of more than 6 wt. %.
67. Edible fat-containing product according to any one of the preceding paragraphs, wherein the structuring fat comprises an amount of C18:0 (stearic acid) from 7 to 57 wt. %.
68. Edible fat-containing product according to any one of the preceding paragraphs, wherein the structuring fat comprises an amount of C18:0 (stearic acid) of more than 7 wt. %.
69. Edible fat-containing product according to any one of the preceding paragraphs, wherein the structuring fat comprises an amount of C18:0 (stearic acid) of more than 8 wt. %.
70. Edible fat-containing product according to any one of the preceding paragraphs, wherein the structuring fat comprises an amount of C18:0 (stearic acid) of more than 9 wt. %.
71. Edible fat-containing product according to any one of the preceding paragraphs, wherein the structuring fat comprises an amount of C18:0 (stearic acid) from 10 to 55 wt. %.
72. Edible fat-containing product according to any one of the preceding paragraphs, wherein the structuring fat comprises an amount of C18:0 (stearic acid) of more than 10 wt %.
73. Edible fat-containing product according to any one of the preceding paragraphs, wherein the structuring fat comprises an amount of C18:0 (stearic acid) of more than 11 wt %.
74. Edible fat-containing product according to any one of the preceding paragraphs, wherein the structuring fat comprises an amount of C18:0 (stearic acid) from 12 to 53 wt. %.
75. Edible fat-containing product according to any one of the preceding paragraphs, wherein the structuring fat comprises an amount of C18:0 (stearic acid) of more than 12 wt. %.
76. Edible fat-containing product according to any one of the preceding paragraphs, wherein the structuring fat comprises an amount of C18:0 (stearic acid) of more than 13 wt. %.
77. Edible fat-containing product according to any one of the preceding paragraphs, wherein the structuring fat comprises an amount of C18:0 (stearic acid) from 15 to 50 wt. %.
78. Edible fat-containing product according to any one of the preceding paragraphs, wherein the structuring fat comprises, calculated on the total amount of structuring fat, an amount of C16:0 (palmitic acid) from 2 to 25 wt %.
79. Edible fat-containing product according to any one of the preceding paragraphs, wherein the structuring fat, calculated on the total amount of structuring fat, comprises an amount of C16:0 (palmitic acid) of less than 25 wt. %.
80. Edible fat-containing product according to any one of the preceding paragraphs, wherein the structuring fat comprises an amount of C16:0 (palmitic acid) from 2 up to less than 25 wt. %.
81. Edible fat-containing product according to any one of the preceding paragraphs, wherein the structuring fat comprises an amount of C16:0 (palmitic acid) from 3 to 22 wt. %.
82. Edible fat-containing product according to any one of the preceding paragraphs, wherein the structuring fat comprises an amount of C16:0 (palmitic acid) from 4 to 20 wt. %.
83. Edible fat-containing product according to any one of the preceding paragraphs, wherein the structuring fat comprises an amount of C16:0 (palmitic acid) from 5 to 15 wt. %.
84. Edible fat-containing product according to any one of the preceding paragraphs, wherein the structuring fat comprises an amount of C16:0 (palmitic acid) of less than 15 wt. %.
85. Edible fat-containing product according to any one of the preceding paragraphs, wherein the structuring fat comprises an amount of C16:0 (palmitic acid) of less than 12 wt. %.
86. Edible fat-containing product according to any one of the preceding paragraphs, wherein the structuring fat comprises an amount of C16:0 (palmitic acid) of less than 10 wt %.
87. Edible fat-containing product according to any one of the preceding paragraphs, wherein the structuring fat comprises an amount of C18:0 (stearic acid) at the 2-position of the glycerol backbone (2-C18:0) from 5 to 60 wt. %, calculated on the total amount of fatty acids on the 2-position of the glycerol backbone of the structuring fat.
88. Edible fat-containing product according to any one of the preceding paragraphs, wherein the structuring fat comprises an amount of C18:0 (stearic acid) at the 2-position of the glycerol backbone (2-C18:0) from 7 to 57 wt. %.
89. Edible fat-containing product according to any one of the preceding paragraphs, wherein the structuring fat comprises an amount of C18:0 (stearic acid) at the 2-position of the glycerol backbone (2-C18:0) from 10 to 55 wt. %.
90. Edible fat-containing product according to any one of the preceding paragraphs, wherein the structuring fat comprises an amount of C18:0 (stearic acid) at the 2-position of the glycerol backbone (2-C18:0) from 12 to 52 wt. %.
91. Edible fat-containing product according to any one of the preceding paragraphs, wherein the structuring fat comprises an amount of C18:0 (stearic acid) at the 2-position of the glycerol backbone (2-C18:0) from 15 to 50 wt. %.
92. Edible fat-containing product according to any one of the preceding paragraphs, wherein the structuring fat comprises an amount of C16:0 (palmitic acid) at the 2-position of the glycerol backbone (2-C16:0) from 0.1 to 15 wt. %, calculated on the total amount of fatty acids on the 2-position of the glycerol backbone of the structuring fat.
93. Edible fat-containing product according to any one of the preceding paragraphs, wherein the structuring fat comprises an amount of C16:0 (palmitic acid) at the 2-position of the glycerol backbone (2-C16:0) of less than 15 wt %.
94. Edible fat-containing product according to any one of the preceding paragraphs, wherein the structuring fat comprises an amount of C16:0 (palmitic acid) at the 2-position of the glycerol backbone (2-C16:0) from 0.5 to 14 wt. %.
95. Edible fat-containing product according to any one of the preceding paragraphs, wherein the structuring fat comprises an amount of C16:0 (palmitic acid) at the 2-position of the glycerol backbone (2-C16:0) of less than 14 wt %.
96. Edible fat-containing product according to any one of the preceding paragraphs, wherein the structuring fat comprises an amount of C16:0 (palmitic acid) at the 2-position of the glycerol backbone (2-C16:0) from 1 to 13 wt. %.
97. Edible fat-containing product according to any one of the preceding paragraphs, wherein the structuring fat comprises an amount of C16:0 (palmitic acid) at the 2-position of the glycerol backbone (2-C16:0) of less than 13 wt %.
98. Edible fat-containing product according to any one of the preceding paragraphs, wherein the structuring fat comprises an amount of C16:0 (palmitic acid) at the 2-position of the glycerol backbone (2-C16:0) from 2 to 12 wt. %.
99. Edible fat-containing product according to any one of the preceding paragraphs, wherein the structuring fat comprises an amount of C16:0 (palmitic acid) at the 2-position of the glycerol backbone (2-C16:0) of less than 12 wt. %.
100. Edible fat-containing product according to any one of the preceding paragraphs, wherein the structuring fat comprises an amount of C16:0 (palmitic acid) at the 2-position of the glycerol backbone (2-C16:0) of less than 11 wt. %.
101. Edible fat-containing product according to any of the preceding paragraphs, wherein the fat-containing product is an emulsion comprising of 20 up to less than 30 wt. % of a fat phase, wt % calculated on the amount of product, wherein the fat phase comprises a liquid vegetable oil and from 20 to 60 wt. % of a structuring fat, wt. % calculated on the fat phase, and wherein the fat phase comprises, calculated on the amount of the fat phase, an amount of C18:0 (stearic acid) from 5 to 15 wt. %.
102. Edible fat-containing product according to any of the preceding paragraphs, wherein the fat-containing product is an emulsion, wherein the fat phase comprises a liquid vegetable oil and from 20 to 60 wt. % of a structuring fat, wt. % calculated on the fat phase, and wherein the fat phase comprises, calculated on the amount of the fat phase, an amount of C18:0 (stearic acid) from 5 to 15 wt. %, wherein the product further comprises 0.01-0.1 wt % PGPR, wt. % calculated on the weight of the product.
103. Method for the preparation of the edible fat-containing product of any one of the preceding paragraphs, the method comprising the steps of:
   providing the aqueous phase;
   providing the fat phase comprising the liquid oil and the structuring fat, preferably in liquid from; and
   mixing at least part of the fat phase with at least part of the aqueous phase to obtain a pre-mix;
   processing the premix, preferably in a margarin unit, to obtain the edible fat-containing product.

1. Edible fat-containing product comprising an aqueous phase and 20-39 wt. % of a fat phase, wt. % calculated on the weight of the product, wherein the fat phase comprises a liquid vegetable oil and 5-90 wt. % of a structuring fat, wt. % calculated on the fat phase,
wherein the structuring fat is an interesterified blend of fats wherein one of the fats in the blend to be interesterified has >95 wt. % C18:0 calculated on the amount of fatty acids of the triglycerides of the fat,
wherein the fats in the blend to be interesterified do not contain
palm oil or palm oil-derived fractions,
hydrogenated oil or fat or fractions thereof,
wherein the liquid vegetable oil does not contain hydrogenated oil or fat or fractions thereof, and wherein the fat phase comprises, calculated on the amount fatty acids of the triglycerides of the fat phase, an amount of C18:0 (stearic acid) from 5 to 25 wt. %.

2. Edible fat-containing product according to claim 1, wherein the edible fat-containing product comprises 20-less than 30 wt. % of the fat phase.

3. Edible fat-containing product according to claim 1, comprising an emulsifier having an HLB of at most 7.

4. Edible fat-containing product according to claim 1, wherein the fat phase comprises from 20 to 60 wt. % of the structuring fat.

5. Edible fat-containing product according to claim 1, wherein the fat phase comprises an amount of C18:0 (stearic acid) from 5 to 15 wt. %.

6. Edible fat-containing product according to claim 1, wherein the fat phase comprises, calculated on the total amount of fatty acids of the triglycerides in the fat phase, an amount of C16:0 (palmitic acid) of less than 15 wt. %.

7. Edible fat-containing product according to claim 1, wherein the fat phase comprises an amount of C18:0 (stearic acid) at the 2-position of the glycerol backbone (2-C18:0) of more than 5 wt. %, calculated on the total amount of fatty acids on the 2-position of the glycerol backbone.

8. Edible fat-containing product according to claim 1, wherein the structuring fat comprises, calculated on the total amount of structuring fat, an amount of C18:0 (stearic acid) from 5 to 60 wt. %.

9. Edible fat-containing product according to claim 1, wherein the structuring fat comprises, calculated on the total amount of structuring fat, an amount of C16:0 (palmitic acid) of less than 25 wt. %.

10. Edible fat-containing product according to claim 1, wherein the structuring fat comprises an amount of C18:0 (stearic acid) at the 2-position of the glycerol backbone (2-C18:0) from 5 to 60 wt. %, calculated on the total amount of fatty acids on the 2-position of the glycerol backbone of the structuring fat.

11. Edible fat-containing product according to claim 1, wherein the fat-containing product is an emulsion comprising of 20 up to less than 30 wt. % of a fat phase, wt. % calculated on the amount of product, wherein the fat phase comprises a liquid vegetable oil and from 20 to 60 wt. % of a structuring fat, wt. % calculated on the fat phase, and wherein the fat phase comprises, calculated on the amount of the fat phase, an amount of C18:0 (stearic acid) from 5 to 15 wt. %.

12. Edible fat-containing product according to claim 1, wherein the fat-containing product is an emulsion, wherein the fat phase comprises a liquid vegetable oil and from 20 to 60 wt. % of a structuring fat, wt. % calculated on the fat phase, and wherein the fat phase comprises, calculated on the amount of the fat phase, an amount of C18:0 (stearic acid) from 5 to 15 wt. %, wherein the product further comprises 0.01-0.4 wt % PGPR, wt. % calculated on the weight of the product.

13. Edible fat-containing product according to claim 1, wherein the fat-containing product is a water-in-oil emulsion.

14. Edible fat-containing product according to claim 1, wherein the edible fat-containing product is a spread.

15. Method for the preparation of the edible fat-containing product of claim 1, the method comprising the steps of:
providing the aqueous phase;
providing the fat phase comprising the liquid oil and the structuring fat, preferably in liquid from; and
mixing at least part of the fat phase with at least part of the aqueous phase to obtain a pre-mix;
processing the premix, preferably in a margarin unit, to obtain the edible fat containing product.
